(19) United States
(12) Patent Application Publication
(10) Pub. No.: US 2004/0244026 A1
(43) Pub. Date: Dec. 2, 2004

(54) Optical disk manufacturing method

(76) Inventors: Mamoru Usami, Tokyo (JP); Yoshimi Sakai, Tokyo (JP); Kenji Yamaga, Tokyo (JP); Hideki Ishizaki, Tokyo (JP)

Correspondence Address: OLIFF & BERRIDGE, PLC, P.O. BOX 19928, ALEXANDRIA, VA, 22320, US

(21) Appl. No.: 10/486,249

(22) PCT Filed: Jul. 31, 2002
(86) PCT No.: PCT/JP02/07830

(30) Foreign Application Priority Data
Aug. 10, 2001 (JP) 2001-244250

(51) Int. Cl. G11B 11/00; B29D 17/00

(52) U.S. Cl. 720/718; 264/1.33; 264/107

(57) ABSTRACT

Without forming a center hole, a light-transmitting resin layer is deposited and formed on a disc-shaped substrate material. A method for fabricating an optical disc includes the steps of injecting a synthetic resin from a gate into the cavity of a mold assembly 30 to mold and cure a disc-shaped substrate material 12 in conjunction with a sprue runner 14 in the gate; depositing a film 18 on the disc-shaped substrate material 12 integrated with the sprue runner 14 taken out of the mold assembly 30; forming a light-transmitting resin layer 22; and forming a center hole 28 by punching through a center portion 26 of the disc-shaped substrate material 12 in conjunction with the sprue runner 14.

### TECHNICAL FIELD

The present invention relates to optical discs and methods for fabricating optical discs, and more particularly to an optical disc having a thinner light-transmitting substrate (a light-transmitting layer) than a conventional one and a method for fabricating the same.

### BACKGROUND ART

In general, disc-shaped optical recording media (optical discs) such as CDs (Compact Discs) or DVDs (Digital Versatile Discs) are fabricated in such a manner that a stamper formed in a mastering step is set in a mold assembly placed in an injection molding machine to injection mold a surface area serving to carry information, thereby forming a resin disc-shaped substrate material. The, substrate material is then provided with a recording layer designed to be recordable, a reflective layer designed to be readable and the like, on which a resin protective layer is formed.

These discs are used to record and/or readout information thereon and/or therefrom by being irradiated with a predetermined laser beam through the disc-shaped substrate material.

Recently, for example, as disclosed in Japanese Patent Laid-Open Publication No. Hei 8-235638, such an optical disc has also become a focus of attention which is fabricated in a manner such that a support layer (protective layer) requiring no transmission of light or having no optical thickness requirements is formed by injection molding to be thicker as the disc-shaped substrate material (substrate). The information recording surface of the substrate is provided with a reflective film designed to be readable or a recording layer designed to be recordable or the like. Then, stacked in layers thereon is a light-transmitting layer (a resin layer corresponding to the protective layer of the aforementioned CD or the like) made of a transparent resin layer that can transmit therethrough a recording/reproduction laser beam.

Conventionally, an optical disc has been fabricated in such a manner that upon injection molding of the substrate, the substrate center portion as well as the sprue runner hardened in the gate during the injection molding are removed to provide a circular center hole at the center portion, thereby forming a disc-shaped substrate material. The reflective film and the recording layer designed to be recordable or the like are also formed, and then, in the subsequent step, a resin protective layer or a light-transmitting layer of a light-transmitting resin are formed, for example, by spin coating to complete the optical disc.

Furthermore, the conventional optical disc may be provided on the light-incident surface of the disc-shaped substrate material with a so-called hard-coat layer similar, to the aforementioned resin protective layer in order to prevent flaws thereon.

As one of the typical methods of fabricating the aforementioned protective layer or light-transmitting layer, such as disclosed in Japanese Patent Laid-Open Publication No. Hei 10-249264, there is a method of forming the protective layer (resin layer) by placing a cover member to cover the center hole of an optical disc therewith and then spin coating a resin thereon to spread and cure it on the entire optical disc. This method facilitates the thickness control over the resin layer especially to make the coated surface substantially uniform in the radial direction, thereby being made applicable also to the formation of the light-transmitting layer according to Japanese Patent Laid-Open Publication No. 1996-235638.

To apply the aforementioned method for spin coating the resin layer to form a more uniform resin layer, a cover member is required which covers the center hole of the disc-shaped substrate material.

According to this fabricating method, the cover member is desired to be clean. When one cover member is always used, a step of cleaning it is required after it is used once for resin coating, or a new (clean) one has to be always used by employing a single-use cover member or the like.

Furthermore, as described above, with the center hole covered with the cover member upon spin coating, the light-transmitting resin typically flows from the position of the cover member down to the disc-shaped substrate material. This raised problems of readily producing air bubbles inside the resin layer and uneven streaks on the resin layer surface, caused by a difference in level between the, cover member and the disc-shaped substrate material surface, and unevenness in layer thickness (film thickness).

On the other hand, for example, as disclosed in Japanese Patent Laid-Open Publications No. Hei 5-92492 and No. Hei 5-185477, suggested are methods of fabricating an optical disc in which the center hole is provided not during the formation of the disc-shaped substrate material but immediately after the formation in order to minimize the effects of burrs or resin chippings resulting from the punching of the center hole.

As described above, since these methods aim to minimize the effects of burrs or resin chippings, they are characterized in that the center hole is formed immediately after the formation, with the center portion as well as the sprue runner having been removed before the formation of the light-transmitting resin layer.

### DISCLOSURE OF THE INVENTION

The present invention was developed from the viewpoint different from that of the aforementioned prior art. It is an object of the present invention to provide a method for fabricating a disc substrate which facilitates the steps and provides an improved fabrication yield of the resin layer as compared with the conventional fabricating method using the cover member, and to provide an optical disc fabricated by this method.

As a result of intensive studies, the inventor designed the injection molding, one of the fabricating steps of an optical disc, such that the disc-shaped substrate material is removed integrally with the center portion and the sprue runner, and then allowed, as it is, to go through the deposition step and the resin layer formation step and the like to form the optical disc.

That is, the aforementioned problems can be solved by the following inventions:

(1) A method for fabricating an optical disc having a center hole at its center portion, the optical disc being designed for information to be recordable and/or readable thereon and/or therefrom by forming various functional layers on a disc-shaped substrate material. The method comprises the step of forming at least a resin layer on the disc-shaped substrate material before the formation of the center hole.

(2). A method for fabricating an optical disc having a center hole at its center portion, the optical disc being designed for information to be recordable and/or readable thereon and/or therefrom by forming various functional layers on a disc-shaped substrate material. The method comprises the step of forming at least a light-transmitting resin layer having a thickness of 10 to 120 μm on the disc-shaped substrate material before the formation of the center hole.

(3) A method for fabricating a disc substrate, comprising: the steps of injecting a synthetic resin from a gate into a cavity of a mold assembly to mold and cure a disc-shaped substrate material in conjunction with a sprue runner in the gate; and forming a resin layer on the surface of the disc-shaped substrate material integrated with the sprue runner holding the disc substrate and removed from the mold assembly.

(4) A method for fabricating a disc substrate, comprising the steps of: injecting a synthetic resin from a gate into a cavity of a mold assembly to mold and cure a disc-shaped substrate material in conjunction with a sprue runner in the gate; and forming a light-transmitting resin layer having a thickness of 50 to 120 μm on the surface of the disc-shaped substrate material integrated with the sprue runner removed from the mold assembly.

(5) A method for fabricating a disc substrate according to any one of (1) to (4) further comprising the step of forming a center hole after completing all the aforementioned steps.

(6) A method for fabricating a disc substrate according to (5), wherein the step of forming a center hole punches through the center portion by ultrasonic pressing.

(7) An optical disc having a center hole at its center portion, the optical disc being designed for information to be recordable and/or readable thereon and/or therefrom by forming various functional layers on a disc-shaped substrate material, wherein at least a resin layer is formed on the disc-shaped substrate material before the formation of the center hole, the center hole being formed with the disc center-portion removed in conjunction with the resin layer on top thereof.

(8) An optical disc having a center hole at its center portion, the optical disc being designed for information to be recordable and/or readable thereon and/or therefrom by forming various functional layers on a disc-shaped substrate material, wherein at least a light-transmitting resin layer having a thickness of 10 to 120 μm is formed on the disc-shaped substrate material before the formation of the center hole, the center hole being formed with a depth portion in the disc center portion removed in conjunction with the resin layer on top thereof.

### BRIEF DESCRIPTION OF THE DRAWINGS

FIG. 1 is a schematic perspective view illustrating a method for fabricating an optical disc according to an embodiment of the present invention;

FIG. 2 is a cross-sectional view illustrating a mold assembly used for the fabricating method;

FIG. 3 is a schematic perspective view, similar to FIG. 1, illustrating a fabricating method according to a second embodiment;

FIG. 4 is a schematic cross-sectional view illustrating steps of forming a center hole and plugging it in the mold assembly;

FIG. 5 is a time chart showing the steps;

FIG. 6 is a schematic perspective view, similar to FIG. 1, illustrating a fabricating method according to a third embodiment of the present invention;

FIG. 7 is a cross-sectional view illustrating a mold assembly used for the fabricating method;

FIG. 8 is a perspective view illustrating the main portion of a vacuum pumping device, used in a step of a fabricating method according to the present invention, for transporting a disc-shaped substrate material;

FIG. 9 is a side view illustrating the disc-shaped substrate material being sucked by the device; and

FIG. 10 is a diagram illustrating the relation between the thickness of a light-transmitting resin layer and the disc radial position of a disc substrate fabricated by a method according to an embodiment of the present invention, in comparison with a conventional example.

### BEST MODE FOR CARRYING OUT THE INVENTION

Now, the present invention will be explained below in more detail with reference to the drawings in accordance with the embodiments.

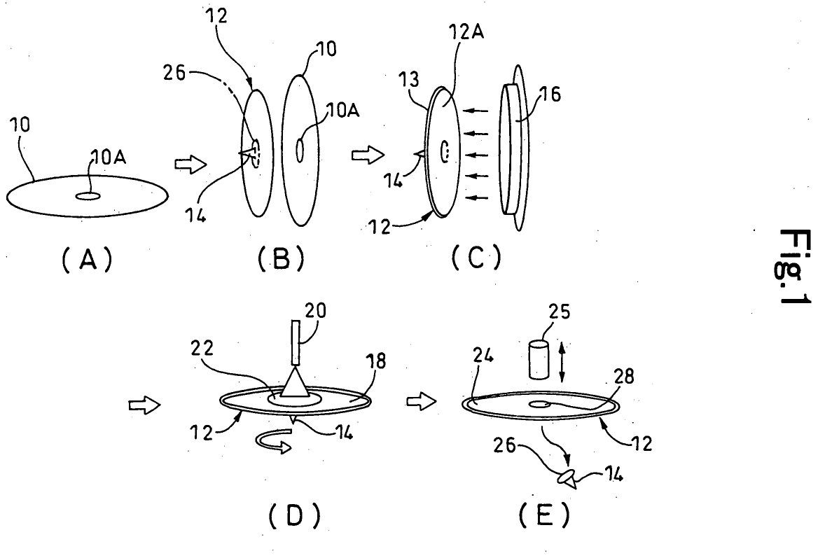

Referring to FIG. 1, a method for fabricating a disc substrate according to a first embodiment of the present invention will be described.

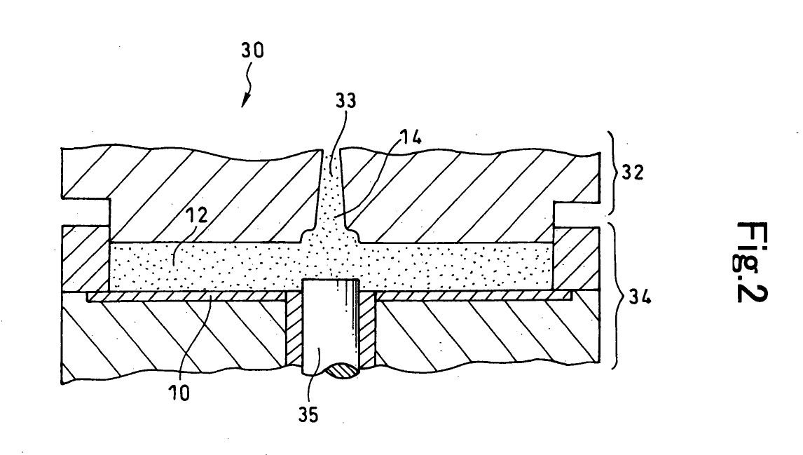

According to this method a stamper 10 (see FIG. 1(A)) on which a pattern for forming an information recording surface is mastered is first set in a mold assembly 30 (see FIG. 2), a synthetic resin being injected into the cavity of the mold assembly 30 to form a disc-shaped substrate material 12.

In the course of the aforementioned injection molding, the disc-shaped substrate material 12 is removed from the mold assembly 30 integrally with a sprue runner 14 without punching through a center portion 26 of the disc-shaped substrate material 12 or without forming a center hole 28. Then, the disc-shaped substrate material 12 is subjected to a sputtering step, a spin coating step, and a hard-coating step and the like, and thereafter the center portion 26 is removed in conjunction with the sprue runner 14.

As shown in FIG. 2, the mold assembly 30 is generally provided on a movable mold 34 with a center-hole forming nest 35, the nest 35 being adapted to protrude toward a stationary mold 32. The stamper 10 has a through hole 10A formed at its center to allow the center-hole forming nest 35 to penetrate therethrough, and is placed on the movable mold 34 in the mold assembly 30, opposite to a gate 33 for injecting synthetic resin.

According to the fabricating method of this embodiment, a synthetic resin is injected into the mold cavity, and then a hardened disc-shaped substrate material 12 is ejected out of the mold assembly 30 without moving the center-hole forming nest 35 toward the stationary mold 32, i.e., without punching through the center portion 26 of the disc-shaped substrate material 12.

The present invention only requires not to form the center hole that would be otherwise usually formed, i.e., to eliminate the step for it, allowing the following method according to a second embodiment to be applicable.

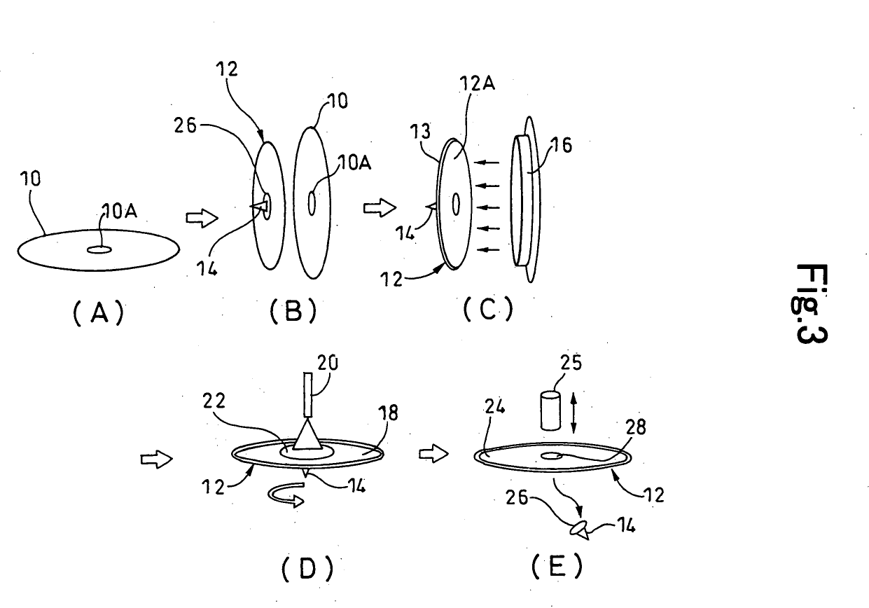

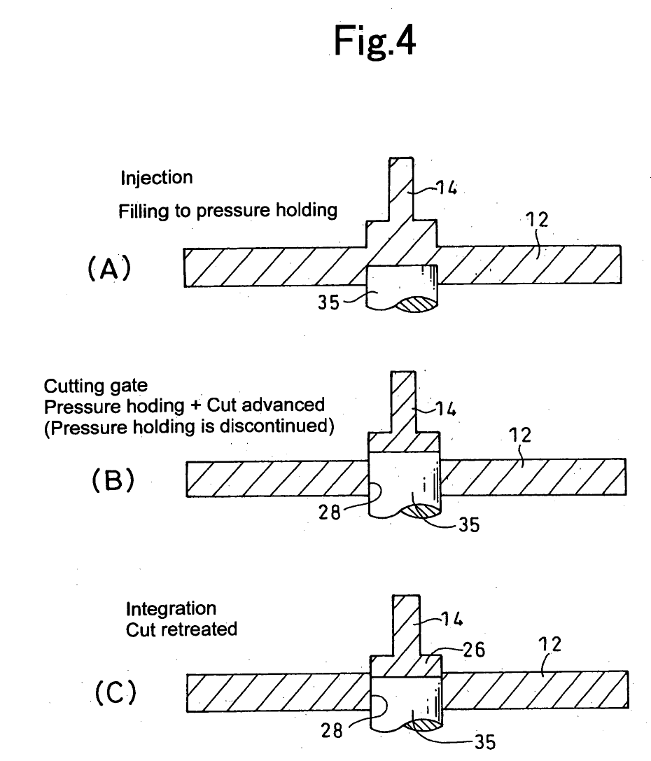

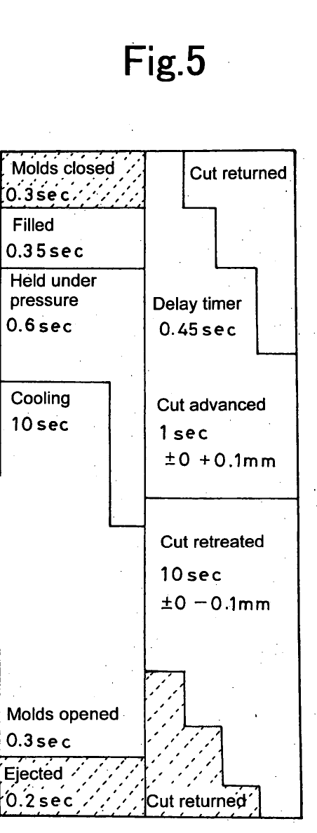

In the method according to the second embodiment, the center hole 28 is once formed in the disc-shaped substrate material 12 using the mold assembly 30, and then plugged with the center portion 26, as shown in FIG. 3(B). This plugging step will be described below with reference to FIGS. 4 and 5.

After a synthetic resin is injected into the mold cavity, the fabricating method according to the second embodiment performs the punching step of moving the center-hole forming nest 35 toward the stationary mold 32 to punch through the center portion 26 of the disc-shaped substrate material 12 held under a pressure in the cavity in conjunction with the sprue runner 14, thereby forming the center hole 28. Subsequently performed is the pushing-back step of pushing back the center portion 26 slightly into the center hole 28 to plug the center hole 28 to be integrated with the disc-shaped substrate material 12. Then, the disc-shaped substrate material 12 is ejected out of the mold assembly 30.

Here, the pushing-back step includes the returning step of returning the center-hole forming nest 35 slightly into the center hole 28, and the plugging step of allowing the resulting difference in pressure of the resin in the cavity to return part of the center portion 26 in the direction of its thickness into the center hole 28 to plug the center hole 28.

The aforementioned punching step and returning step will be explained in more detail with reference to FIGS. 4 and 5.

In the step of injecting resin, the resin is filled in the cavity and held under a pressure as shown in FIG. 4(A). For example, as shown in FIG. 5, up to this step, it takes 0.2 to 0.5 seconds to close the mold assembly, 0.1 to 0.6 seconds to fill it with resin, and 0.1 to 3 seconds to hold the resin under a pressure.

On the other hand, a delay timer is used to allow the center-hole forming nest 35 to start advancing (rising in FIG. 4) 0 to 1.0 second after the start or the completion of injection. At this time, as shown in FIG. 4(B), the center portion 26 of the disc-shaped substrate material 12 is pushed out upwardly (punched through) in the figure from the center hole 28 formed by the center-hole forming nest 35.

The thickness of the center portion 26 is thinner as compared with that of FIG. 4(A) because the resin still remaining flowable upon lifting the center-hole forming nest 35 escapes sideways.

This step of punching with the center-hole forming nest 35 is generally carried out during the pressure holding step. The completion of the pressure holding is followed by a cooling step that lasts for 10 seconds as shown in FIG. 5.

On the other hand, as shown in FIG. 5, the center-hole forming nest 35 is subjected to the returning step for 10 seconds immediately after the completion of the punching step. When the tip of the center-hole forming nest 35 has returned into the center hole 28, the pressure in the mold assembly 30 causes the center portion 26 to be pushed back into the center hole 28 in conjunction with the sprue runner 14.

After the cooling is completed, the mold assembly is opened and the disc-shaped substrate material 12 is held to be ejected therefrom, with the center hole 28 being plugged with the center portion 26 and the center portion 26 and the sprue runner 14 being integrated with the disc-shaped substrate material 12.

In this condition, a film is deposited and a light-transmitting resin layer 22 is formed as shown in FIGS. 3(C) and 3(D), and then the center portion 26 is pushed out to be easily removed as shown in FIG. 3(E).

Furthermore, when the center portion 26 is once punched from the disc-shaped substrate material 12 and returned into the center hole 28, the inner circumferential edge of the center hole 28 is rubbed by the center portion 26, thereby allowing a smooth edge to be made.

In the aforementioned embodiment, the center-hole forming nest 35 is slightly returned after the punching step. This may also be implemented such that with the center-hole forming nest 35 allowed to remain, the movable mold 34 is driven slightly toward the stationary mold 32 causing relatively the tip of the center-hole forming nest 35 to return into the center hole 28.

Furthermore, the time for the pressure holding step shown in FIG. 5, the operating time of the delay timer, the time and distance of the advancing step and the distance of the retreating step of the center-hole forming nest 35 are not limited thereto. Controlling these parameters makes it possible to control the adhesiveness and removability of the center portion 26 to and from the center hole 28 and burrs near the center hole 28.

The disc-shaped substrate material according to the present invention is also preferably formed in the following manner. That is, for the step of forming the center hole of FIG. 1 simply being not carried out or being eliminated, the circular line segment or the outer circumference of the center hole is made thin by allowing the center-hole forming nest 35 to slightly project or the like upon forming the cavity in advance in order to facilitate the formation of the center hole in a subsequent step.

The surface on which the resin layer is formed preferably has no step height preventing the resin from spreading to facilitate formation of a uniform resin layer on the optical disc upon forming the resin layer by spin coating in the subsequent step. That is, to form the resin layer on a layer of the disc-shaped substrate material, the layer being formed to be recordable and/or readable, no step height mentioned above is preferably present on this side.

That is, The disc-shaped substrate material 12, which is fabricated according to the aforementioned method and has the sprue runner 14 remaining in the gate 33 integrally formed therewith at the position of the disc center, is then provided by sputtering or by spin coating with a recording layer designed to be recordable and a reflective layer specially designed to be readable. On the layers, a resin is spread by spin coating and cured on the entire optical disc, thereby forming a protective layer or a light-transmitting layer (resin layer)

For the disc-shaped substrate material 12 formed integrally with the sprue runner 14 (a projected portion) which remains in the gate 33 and which is projected at the position of the disc center, the information recording layer can be formed on the projected side or the side opposite thereto and may be formed on the either side. This is determined depending on which side of the mold assembly, the movable or stationary side thereof, the stamper 10 is placed on, i.e., especially depending in the present invention on whether the stamper 10 is placed on a punching pin side or not.

In the foregoing, FIGS. 1 and 3 illustrate the case in which the information layer (an information recording surface 12A) to be transferred by the stamper is provided on the side having no projected portion. This case will be explained in detail with reference to the subsequent steps.

The disc-shaped substrate material 12 has a recording layer, including a dye layer, formed by spin coating, or a recording layer formed by sputtering to allow magneto-optical recording or phase change recording. Below and above the recording layer, layers such as a dielectric layer are formed by sputtering for various purposes. Furthermore, a reflective layer is then formed which is made of metal. On the other hand, to fabricate a read-only optical disc, only a unit reflective layer is formed.

These recording layer, dielectric layer, and unit reflective layer are collectively shown as a film 18 in FIG. 1 (D).

For the spin coating, the center portion of the area on which the disc-shaped substrate material is placed may be provided with a clearance just enough to accommodate a projected portion including the sprue runner 14. This also holds true for the sputtering. For the sputtering, an inner and outer circumferential mask for covering the portion that requires no deposition is used. In this case, as shown in FIGS. 1(C) and 3(C), the outer circumference may be masked with an outer circumferential mask 13 in a usual manner without using an inner circumferential mask. Alternatively, the inner circumferential mask may be provided near the center portion of a disc-shaped sputtering target 16.

Then, as shown in FIGS. 1(D) and 3(D), while the disc-shaped substrate material 12 is being rotated in a horizontal plane with the sprue runner 14 disposed downwardly, a resin material (light-transmitting resin) is dispensed from a nozzle 20 to form a resin layer (light-transmitting resin layer) 22 on the film 18 by spin coating (FIGS. 1(D) and 3(D) show the resin extending halfway in the radial direction of the disc-shaped substrate material).

At this time, the center portion of the area in which the disc-shaped substrate material is placed is provided with a clearance portion just enough to accommodate the projected portion. There is no optical disc center hole near the center portion of the disc-shaped substrate material. Thus, without using a cover member for covering the center hole of the optical disc as disclosed in Japanese Patent Laid-Open Publication No. Hei 10-249264 mentioned above the resin can be spread by spin coating and cured on the entire optical disc, thereby allowing a protective layer (resin layer) to be formed. This makes it possible to provide control over the coated surface such that the thickness of the resin layer is made generally uniform especially in the radial direction.

Likewise, a hard-coat protective layer 24 may also be formed on the resin layer 22.

Then, for example, as shown in FIGS. 1(E) and 3(E), a punch 25 of an ultrasonic press is used to punch through the center portion 26 of the disc-shaped substrate material 12 in conjunction with the sprue runner 14 to form the center hole 28.

At this time, upon ultrasonic pressing, the disc-shaped substrate material 12 is positioned relative to the pattern of the information recording surface 12A. Alternatively, when the gate 33 is so set as to stay at the center of the disc-shaped substrate material 12, the disc-shaped substrate material 12 may also be positioned with respect to the sprue runner 14.

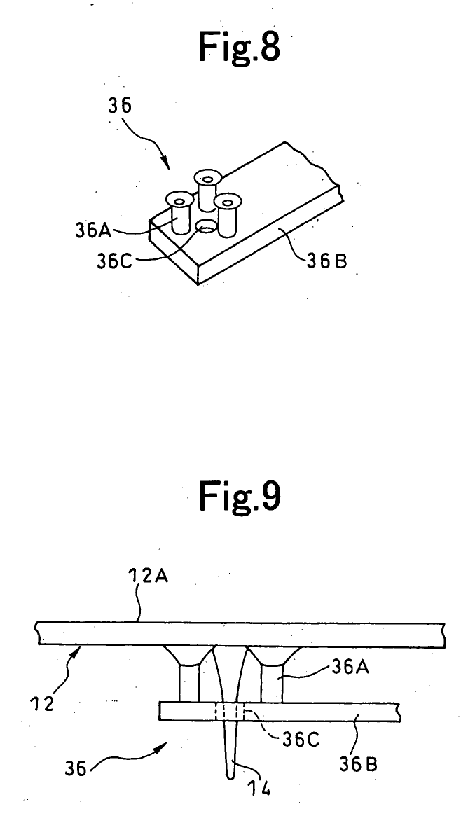

In FIGS. 1 and 3, the disc-shaped substrate material 12 formed by injection is transported grasping the surface having the sprue runner 14 formed, i.e., the surface opposite to the information recording surface 12A. For example, a vacuum pumping device 36 shown in FIGS. 8 and 9 may suck the side opposite to the information recording surface 12A of the disc-shaped substrate material 12 for transportation, or the outer circumferential portion thereof may be mechanically chucked (hooked with claws). Alternatively, the sprue runner 14 may also be grasped for transportation.

The vacuum pumping device 36 is provided at the tip of a transport arm 36B with a plurality of suction pads 36A (three pads in FIGS. 8 and 9) made of silicon or the like, vacuuming the side opposite to the information recording surface 12A of the disc-shaped substrate material 12 by applying a negative pressure to the suction pads 36A. The transport arm 36B is provided at the center of the three suction pads 36A with a clearance hole 36C to prevent the interference with the sprue runner 14 of the sucked disc-shaped substrate material 12.

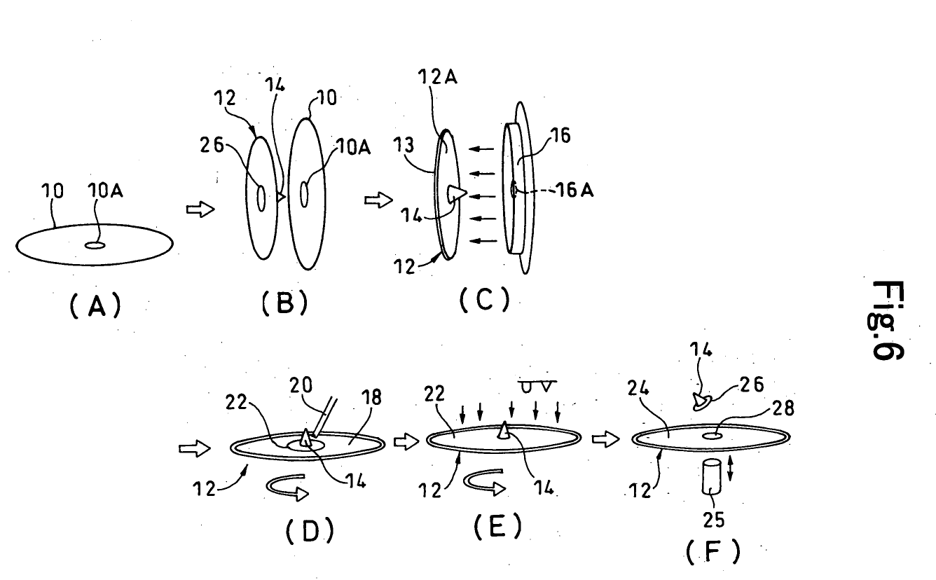

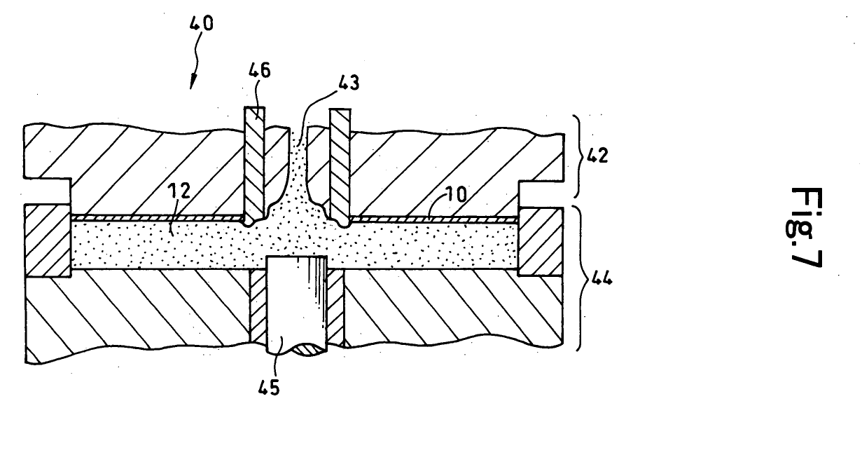

Likewise, the information recording surface 12A to be transferred by the stamper may be provided on the projected portion of the sprue runner 14, the subsequent steps in the case of which will be explained below with reference to FIGS. 6 and 7.

As shown in FIG. 7, a mold assembly 40 employed in this case has the stamper 10 provided on a stationary mold 42 with a gate 43 surrounded by a stamper retainer 46 which penetrates the through hole 10A. In the figure, a movable mold and a center hole forming nest are indicated by the reference numerals 44 and 45, respectively.

Accordingly, in the disc-shaped substrate material 12, the information recording surface 12A is formed on the same side as that of the sprue runner 14 as shown in FIG. 6(C).

In the case of the sputtering, as shown in FIG. 6(C)., the outer circumferential mask 13 can be used to mask the outer circumference as in the usual manner; however, the inner circumferential mask cannot be used. Moreover, since the sprue runner 14 projects toward the sputtering target, a clearance portion. 16A has to be formed near the center portion of the disc-shaped sputtering target as shown by the dashed line in FIG. 6(C).

The subsequent steps are the same as those of the fabricating method of FIG. 1 described above.

To use the spin coating, the sprue runner 14 is disposed at the center portion of the area on which the disc-shaped substrate material is placed. Thus, while the disc-shaped substrate material 12 is being rotated in a horizontal plane with the sprue runner 14 oriented upwardly, a resin material (light-transmitting resin) is dispensed from the nozzle 20 to the vicinity of the sprue runner 14 to form the resin layer (light-transmitting resin layer) 22 (see FIG. 6(D)) on the film 18.

As disclosed in Japanese Patent Laid-Open Publication No. Hei 10-249264 mentioned above, the resin material should be dispensed as close to the sprue runner 14 as possible in order to make the resin layer formed as uniform in thickness as possible.

As shown in FIG. 6(E), the light-transmitting resin layer 22 of an UV curable resin may be irradiated with an ultraviolet (UV) radiation and, if necessary, the hard-coat layer 24 may be formed as shown in FIG. 6(F) to punch through the center portion 26 with the punch 25 of the ultrasonic press.

In FIG. 1, the disc-shaped substrate material 12 formed by injection is transported grasping the surface opposite to the side having the sprue runner 14 formed, i.e., the inner circumference portion or the outer circumference portion of the surface on the information recording surface 12A side. For example, the vacuum pumping device 36 may suck the inner circumference portion of the information recording surface 12A of the disc-shaped substrate material 12 for transportation, or the outer circumferential portion may be mechanically chucked (hooked with claws). Alternatively, the sprue runner 14 may also be grasped for transportation.

In the embodiments shown in FIGS. 1, 3, and 6, the ultrasonic press punches through the center portion 26 of the disc-shaped substrate material 12 in the final step; however, the present invention is not limited thereto and various punching methods may also be applicable.

In a method for fabricating a disc substrate according to these embodiments, a mask for covering the center hole of the disc-shaped substrate material 12 in the spin coating step is not required, thereby allowing the mask or a replacement member and the step of attaching and detaching the mask to be eliminated. Moreover, the absence of a mask makes it possible to prevent air bubbles or uneven streaks in the dispensed material upon spin coating. This makes the method advantageous in the cases where the resin layer to be formed is used as a light-transmitting layer, or a spacer layer (or a layer between the first and second recording layers) of a two-layered disc designed to be recordable and/or readable is formed according to the same method.

Furthermore, since the center portion 26 is punched in the final step, it is possible to prevent detrimental effects i-n the spin coating step or the sputtering step which were conventionally caused by resin particles resulting from burrs dropping off during the molding step.

### EXAMPLE 1

An optical disc was fabricated as shown below which employed a resin layer as a light-transmitting layer.

First, in the same manner as shown in FIG. 7, a stamper formed separately in advance to have information was secured to the stationary mold of a mold assembly than injection molding machine. Here, arrangements were made such that a molten resin material was supplied through the center hole of the stamper from the vicinity of the center of the stationary mold and a disc-shaped substrate material is formed in the cavity defined such as with the mirror surface of the movable mold. A center-hole forming nest was provided near the center of the movable mold to be able to form a center hole by punching near the center of the disc-shaped substrate material.

In the step of injecting resin into the cavity to form the disc-shaped substrate material, settings were made such that the molds were closed in 0.3 seconds, and the resin was filled in the cavity and held under a pressure in 0.35 and 0.6 seconds, respectively.

On the other hand, a delay timer was used to allow the center-hole forming nest to advance 0.45 seconds after the initiation of injection, thereby raising it 0.3 mm in about 0.1 seconds. This allowed the center portion of the disc-shaped substrate material to be provided with a center hole by the center-hole forming nest and once pushed above the center hole. The pressure holding is interrupted during the punching step using the center-hole forming nest. The termination of the pressure holding was followed by the cooling step for about 10 seconds.

On the other hand, the center-hole forming nest was subjected to the returning step for 10 seconds immediately after the termination of the punching step.

When the tip of the center-hole forming nest has returned, a pressure in the mold assembly causes the center portion to be pushed back into the center hole of the disc-shaped substrate material in conjunction with the sprue runner.

The cooling is terminated and the molds were opened to complete the disc-shaped substrate material having the center portion and the sprue runner integrated therewith. That is, the center hole was plugged with the center portion.

A phase-change recording layer was formed by sputtering on an information region of the disc-shaped substrate material formed in this manner, the information region being formed on the projected portion side of the sprue runner. A clearance portion was formed near the target center in order to prevent interference with the sprue runner projected during the sputtering. To form the phase-change recording layer, a reflective film of metal was first formed, and then a GeSbTe-based recording film was formed thereon with a dielectric layer further formed on the recording film.

Furthermore, formed thereon was a light-transmitting resin layer. To form the light-transmitting resin layer, the center hole is typically used for alignment to coat the resin by spin coating. However, since no center hole was formed in this case, a slight step height formed near the center hole was used for alignment. The disc-shaped substrate material was then sucked near the center portion thereof on the side opposite to the recording layer to be thereby secured. The resin was then dispensed near the sprue runner and spun to be thereby entirely spread. The resin was then irradiated with an ultraviolet radiation (UV) to be cured, thereby forming a light-transmitting resin layer of about 100 μm.

Subsequently, the center portion plugging the center hole was ejected from opposite to the sprue runner to be removed, thereby completing an optical disc.

The optical disc completed in this manner facilitates rotation at the time of spin coating as compared with the conventional method of forming a resin layer. Moreover, since the resin is dispensed from near the center portion, a generally uniform resin layer can be formed in the radial direction, and no additional material or a cover is not required. Thus, when compared with the conventional method employing a cover member, this makes it possible to provide multiple effects of simplified steps as well as reduced wastes.

### EXAMPLE 2

Likewise, as shown in FIG. 2, an optical disc having a resin layer as a light-transmitting layer was fabricated in the same manner as in Example 1 except that the stamper was secured in the movable mold of the injection molding machine.

A recording layer was formed on an information region of the disc-shaped substrate material formed in the same conditions as those of Example 1, the information region being formed on the side opposite to the projected portion of the sprue runner. A clearance portion was formed near the center of a member for placing the disc-shaped substrate material in order to prevent the sprue runner projected to the side opposite to that of the example from interfering with the placement of the substrate material.

A light-transmitting resin layer was also formed on the film formed by the sputtering. Here, a clearance portion was formed near the center of the member for placing the disc-shaped substrate material in the spin coater. Then, a step height near the center hole formed by projecting the sprue runner was used for alignment. Then, the disc-shaped substrate material was sucked near the center portion thereof to be secured. The resin was then dispensed to the vicinity of the center portion formed with a slight step height and spun to be thereby entirely spread. The resin was then irradiated with an ultraviolet radiation (UV) to be cured, thereby forming a light-transmitting resin layer of about 100 μm.

Subsequently, the center portion plugging the center hole was ejected from the light-transmitting resin layer side to, be thereby removed, thus completing an optical disc.

The optical disc completed in this manner facilitates rotation at the time of spin coating as compared with the conventional method of forming a resin layer. Moreover, since the resin is dispensed generally from the center portion, a substantially more uniform resin layer can be formed in the radial direction than in Example 1, and no additional material or a cover is not required. Thus, when compared with the method employing a cover member, this makes it possible to provide multiple effects of simplified steps as well as reduced wastes.

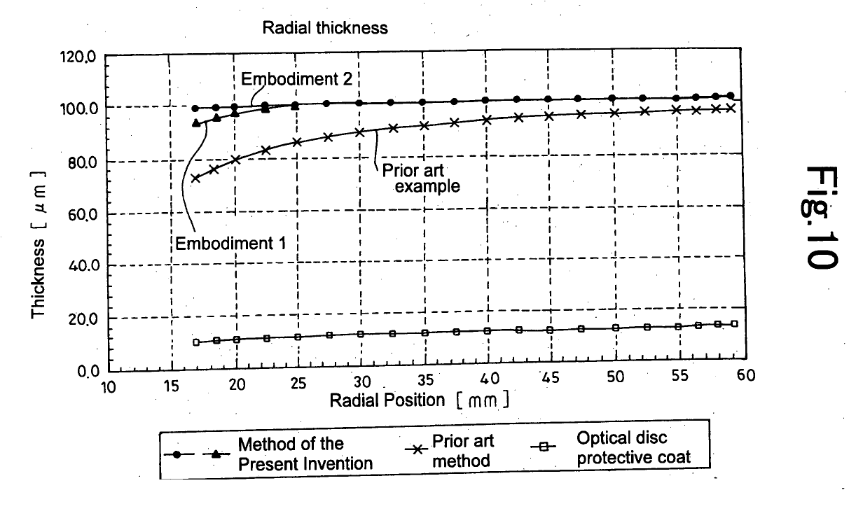

FIG. 10 illustrates the relation between the radial position and the thickness of a light-transmitting resin layer (UV resin) coated on the disc-shaped substrate material according to Embodiments 1 and 2, as compared with a conventional disc-shaped substrate material having a center hole. In the lower portion of FIG. 10, shown is the relation between the disc radial position and the thickness of a protective coat.

As can also be seen from FIG. 10, for the conventional disc-shaped substrate material having a center hole, the thickness of the light-transmitting resin layer is reduced radially toward the center of the disc but increased radially away therefrom, thus causing variations in thickness. However, according to the present invention, the disc-shaped substrate material is uniform in thickness regardless of the radial position.

### INDUSTRIAL APPLICABILITY

The present invention is adapted as described above, and thus makes it possible to form a resin layer, especially one having a relatively increased thickness of about 100 μm, generally uniform in the radial direction. Additionally, since no separate cover member is required, good multiple effects of simplified steps and reduced wastes are provided.

1-8 Cancelled.

9. A method for fabricating an optical disc having a center hole at a center portion thereof, the optical disc being designed for information to be recordable and/or readable thereon and/or therefrom by forming various functional layers on a disc-shaped substrate material, wherein the method comprises the step of forming at least a resin layer on the disc-shaped substrate material before the formation of the center hole.

10. The method for fabricating a disc substrate according to claim 9, further comprising the step of forming a center hole after completing all the aforementioned steps.

11. A method for fabricating an optical disc having a center hole at a center portion thereof, the optical disc being designed for information to be recordable and/or readable thereon and/or therefrom by forming various functional layers on a disc-shaped substrate material, wherein the method comprises the step of forming at least a light-transmitting resin layer having a thickness of 10 to 120 μm on the disc-shaped substrate material before the formation of the center hole.

12. The method for fabricating a disc substrate according to claim 11, further comprising the step of forming a center hole after completing all the aforementioned steps.

13. A method for fabricating a disc substrate, comprising the steps of: injecting a synthetic resin from a gate into a cavity of a mold assembly to mold and cure a disc-shaped substrate material in conjunction with a sprue runner in the gate; and forming a resin layer on the surface of the disc-shaped substrate material integrated with the sprue runner holding the disc substrate and removed from the mold assembly.

14. The method for fabricating a disc substrate according to claim 13, wherein the step of forming a center hole punches through the center portion by ultrasonic pressing.

15. A method for fabricating a disc substrate, comprising the steps of: injecting a synthetic resin from a gate into a cavity of a mold assembly to mold and cure a disc-shaped substrate material in conjunction with a sprue runner in the gate; and forming a light-transmitting resin layer having a thickness of 10 to 120 μm on the surface of the disc-shaped substrate material integrated with the sprue runner removed from the mold assembly.

16. The method for fabricating a disc substrate according to claim 15, further comprising the step of forming a center hole after completing all the aforementioned steps.

17. An optical disc having a center hole at a center portion thereof, the optical disc being designed for information to be recordable and/or readable thereon and/or therefrom by forming various functional layers on a disc-shaped substrate material, wherein at least a resin layer is formed on the disc-shaped substrate material before the formation of the center hole, the center hole being formed with the disc center portion removed in conjunction with the resin layer on top thereof.

18. An optical disc having a center hole at a center portion thereof, the optical disc being designed for information to be recordable and/or readable thereon and/or therefrom by forming various functional layers on a disc-shaped substrate material, wherein at least a light-transmitting resin layer having a thickness of 10 to 120 μm is formed on the disc-shaped substrate material before the formation of the center hole, the center hole being formed in the disc center portion removed in conjunction with the resin layer on top thereof.
